(19) United States
(12) Patent Application Publication
(10) Pub. No.: US 2025/0388609 A1
(43) Pub. Date: Dec. 25, 2025

(54) BIS(ORTHO-CARBORANYL)BORYL ANIONS AND METHODS FOR SYNTHESIS THEREOF

(71) Applicant: BAYLOR UNIVERSITY, Waco, TX (US)

(72) Inventors: Caleb Martin, Waco, TX (US); Kanika Vashisth, Waco, TX (US); Ragene Thornton, Waco, TX (US)

(73) Assignee: BAYLOR UNIVERSITY, Waco, TX (US)

(21) Appl. No.: 19/247,488

(22) Filed: Jun. 24, 2025

Related U.S. Application Data
(60) Provisional application No. 63/663,277, filed on Jun. 24, 2024.

(51) Int. Cl. C07F 5/02

(52) U.S. Cl. CPC C07F 5/027

(57) ABSTRACT

Acyclic boryl anions, such as bis(1-methyl-ortho-carboranyl)boryl anions, disclosed herein feature two bonding pairs and one lone pair of electrons on a boron center. The boryl anions include a counter cation of a Group I metal and are reactive as nucleophiles. The boryl anions can be generated in situ and used as reagents.

This application claims priority to U.S. Provisional Patent App. Ser. No. 63/663,277, entitled “Bis (Ortho-Carboranyl) Boryl Anions and Methods for Synthesis Thereof,” filed on Jun. 24, 2024, the entire contents of which are hereby incorporated by reference.

The present disclosure relates to boryl anions and methods for synthesizing boryl anions.

Boryl anions are strong sigma donors in transition-metal and main group chemistry, as well as useful nucleophiles with organic substrates (aldehydes, ketones, carbon dioxide, nitriles, organohalides, etc). Boron based boryl anions are scarce in literature although base stabilized boryl anions are more prevalent. Base stabilized versions are akin to amines while the non-stabilized are akin to carbenes (CX₂) and nitrenes (NX₂) having 6 valence electrons. FIGS. 1(a)-1(d) shows various structures of conventional forms of known boryl anions. The boryl anions can react with electrophiles to generate organoboranes or metal compounds. Transition metal boryl compounds are intermediates in many catalytic boron-based transformations.

### BACKGROUND

This invention was made with government support under grant 1753025 and 2349851 awarded by the National Science Foundation. The government has certain rights in the invention.

### SUMMARY

The present disclosure pertains to boryl anions and their synthesis, and particularly to a process to synthesize bis(ortho-carboranyl)boryl anions.

Since boron typically has an empty p-orbital, boron reagents are generally considered electrophilic. A boryl anion is a substance which bears two bonding pairs and one lone pair on the boron center. Due to the electronegativity difference between the boron center and the metal ion, the boron carries a negative charge. Thus it is classified as electron rich and nucleophilic. Nucleophilic boron opens new pathways in inorganic and organic chemistry.

Bis(1-methyl-ortho-carborane)bromo borane (“XB^{Me}oCb₂, X=Cl, Br, I”) and bis(1-methyl-ortho-carborane)borane (“HB^{Me}oCb₂”) have been reported. As a reagent, XB^{Me}oCb₂, X=Cl, Br, I is a source for synthesizing the very powerful hydroborating agent HB^{Me}oCb₂. The synthesis of XB^{Me}oCb₂ (X=Cl, Br) is preferably carried out using a one-step process and the commercially available reagents methyl-ortho-carborane, BBr₃ or BCl₃, and n-BuLi.

The present disclosure relates to an acyclic boryl anion MB^{R}oCb₂ bearing carborane (^{R}oCb) electron withdrawing groups. Preferred embodiments herein relate to the synthesis of the boryl anions of this sort as well as their alkali metal complexes. The boryl anions disclosed herein are preferably synthesized by reduction of the halo-borane (XB^{R}oCb₂). In preferred examples of this process, BrB^{R}oCb₂ is reacted with excess metal (M=Na, K) in toluene at 110° C. for at least 6 h to produce metal salts of boryl carborane anions as yellow crystalline solids.

The CH₃ protons on methyl-carborane are the most diagnostic in the ¹H NMR spectrum and appear as a singlet at 2.16 ppm.

Preferred examples of the boryl anions disclosed herein—including KB^{Me}oCb₂ —are useful in carrying out cycloaddition reactions with 3,4,5,6-tetrachloro-quinone, are reactive with the solvent dichloromethane, can be reacted with electrophiles such as copper metal complexes.

### BRIEF DESCRIPTION OF DRAWINGS

FIG. 1 shows structures of various conventional forms of known boryl anions.

FIG. 2 shows general synthetic routes for exemplary boryl anions disclosed herein, MB^{Me}oCb₂, using reduction.

FIG. 3 shows general routes demonstrating reactivity of exemplary boryl anions disclosed herein, MB^{Me}oCb₂.

FIG. 4 shows a crystal structure of [HClB^{Me}oCb₂][K-dibenzo-18-crown-6].

FIG. 5 shows a crystal structure of [K-18-crown-6][TCQB^{Me}oCb₂].

FIG. 6 shows a crystal structure of [PPh₃CuB^{Me}oCb₂].

FIG. 7 shows a structure of an exemplary boryl anion according to preferred embodiments disclosed herein.

FIG. 8 shows a structure of an additional exemplary boryl anion according to preferred embodiments disclosed herein.

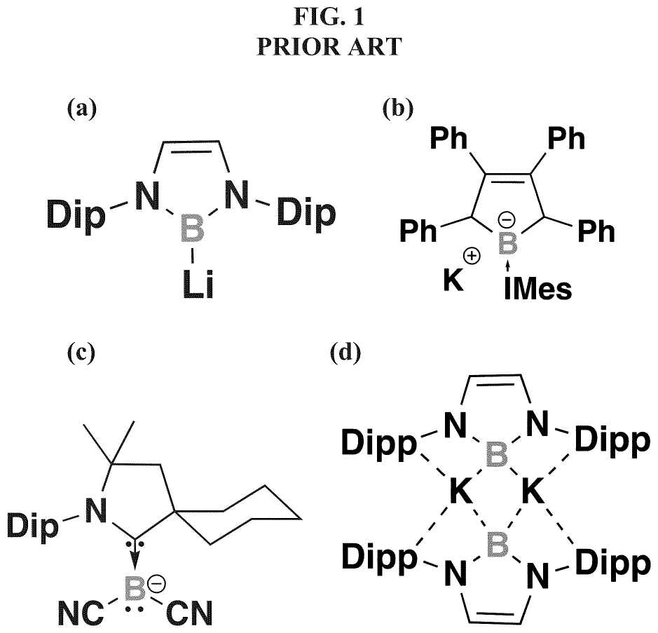

### DETAILED DESCRIPTION OF PREFERRED EMBODIMENTS

The present disclosure relates to a class of compounds, namely boryl anions, that feature two bonding pairs and one lone pair of electrons on a boron center. The boryl anions are isoelectronic to a carbene or a nitrenium center.

Preferred embodiments disclosed herein relate to acyclic bis(ortho-carboranyl)boryl anions having a structure MB^{R}oCb₂ where M is a cation of a Group 1 atom, such as Li, Na, or K, or M is a crown ether/cryptand complexed with the cation of a Group I atom, or M is a Group I atom combined with ammonium or phosphonium or any other suitable spectator cation, and R is any organic substituent. The boryl anions disclosed herein include two derivatives of an ortho-carborane structure ^{R}oCb having general formula oC₂B₁₀H₁₂, designated ^{R}oCb₂; and a central boron atom B. Additional preferred embodiments relate to a bis(1-methyl-ortho-carboranyl)boryl anion with a counter cation, such as potassium, which is an acyclic boryl anion that features a lone pair on a boron center that weakly interacts with the cation in that solid state. The boryl anions according to preferred embodiments disclosed herein can be generated in situ and used as reagents.

Preferred embodiments disclosed herein relate to boryl anions having the structure shown in FIG. 7, wherein each icosohedron structure is an ortho-carborane unit where ⋅ is BH, wherein M is a Group I metal such as Li, Na, or K, and wherein R is an organic substituent such as methyl.

Additional preferred embodiments disclosed herein relate to boryl anions having the structure shown in FIG. 8, wherein each cyclic structure is an ortho-carborane unit where ⋅ is BH, wherein M-crown is a crown ether, or a chelating ether or amine, complexed with a Group I metal such as Li, Na, or K, and wherein R is an organic substituent such as methyl.

Additional preferred embodiments disclosed herein relate to boryl anions represented by MB^{Me}oCb₂, where M is a Group I metal such as Li, Na, or K and each molecule has two methyl-ortho-carborane units. Methyl-ortho-carborane has a chemical formula of oC₃B₁₀H₁₄. The structure of methyl-ortho-carborane is an icosahedron with a C₂B₁₀ core, with an exocage methyl group on ortho-carbon. Methyl-ortho-carborane (C₃B₁₀H₁₄) is abbreviated as ^{Me}oCb. Thus, the two methyl-ortho-carboranes are designated as the ^{Me}oCb₂ portion in MB^{Me}oCb₂. One of the carbon atoms from each ^{Me}oCb moiety is bound to the central boron atom.

Exemplary boryl anion molecules according to preferred embodiments disclosed herein may have different substituents other than Me on the ortho carbon of the carborane, i.e. ^{R}oCb, where R is any organic substituent.

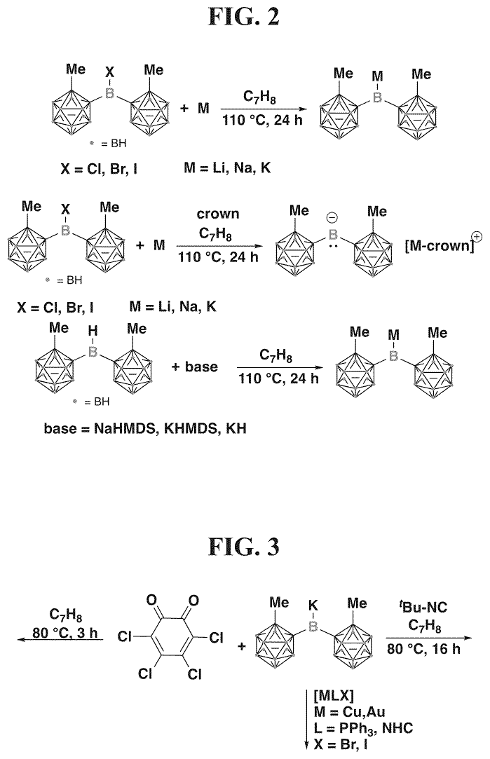

Additional preferred embodiments disclosed herein relate to methods for synthesizing boryl anions represented by MB^{R}oCb₂. FIG. 2 shows different general synthetic routes to prepare preferred embodiments of boryl anions according to preferred embodiments disclosed herein, having the structure of MB^{Me}oCb₂, via reduction. In preferred embodiments, the process of synthesizing a bis(1-methyl-ortho-carborane)boryl anion (such as KB^{Me}oCb₂), comprises first treating XB^{R}oCb₂, where X is a halogen such as Cl, Br, or I and wherein R is an organic substituent such as methyl (such as BrB^{Me}oCb₂), with 2.5 equivalents of a metal (such as K) and toluene (C₇H₈), wherein the temperature is 110° C., and wherein said reaction period is at least 6 h to obtain the desired product. Additional steps in the process may include adding toluene to the reaction mixture, filtering the filtrate through a celite pad, evaporating the solvent, and drying it to produce a yellow crystalline solid.

Preferred embodiments of the boryl anions disclosed herein are reactive with metal reagents as nucleophiles to form metal complexes and intermediates. In the reaction of MB^{R}oCb₂ with metal reagents (such as MPPh₃Cl: M=Cu) metal boryl complexes are generated.

### EXAMPLE 1

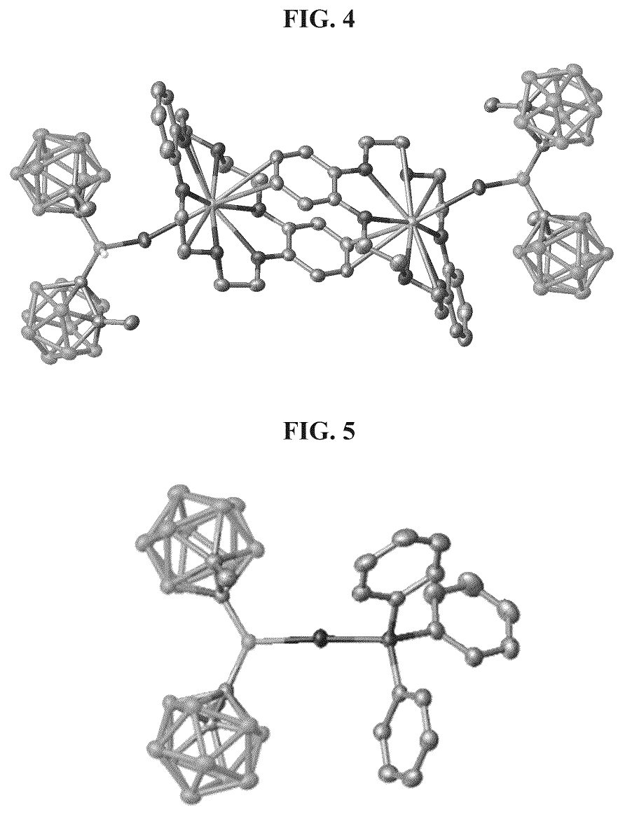

FIG. 3 shows different general synthetic routes illustrating the reactivity of KB^{Me}oCb₂. In the reaction of KB^{Me}oCb₂ with tetrachloro-quinone at 80° C. for a period of 2 hrs, a very broad peak at approximately 7.0 ppm in ¹¹B NMR spectroscopy was shown which implies the reaction of cycloaddition at the OCCO moiety of the reagent. In the reaction of KB^{Me}oCb₂ with tetrachloro-quinone at 80° C. for a period of 2 hrs, a very broad peak at approximately 7.0 ppm in ¹¹B NMR spectroscopy was shown which implies the reaction of cycloaddition at the OCCO moiety of the reagent. The reaction of KB^{Me}oCb₂ with dibenzo-18-crown-6, with CH₂Cl₂ as a solvent, results in the formation of [HClB^{Me}oCb₂][K-dibenzo-18-crown-6]. The formation of the product was confirmed by the X-ray crystallographic studies shown in FIG. 4.

The steps for synthesizing KB^{Me}oCb₂ comprise starting with BrB^{Me}oCb₂ and treating it with 2.5 equivalents of K metal, C₇H₈ at a temperature 110° C. for period of 6 hours. In this example, inside a glove box, a pressure tube was charged with toluene solution of BrB^{Me}oCb₂ (0.31 mmol, 125.5 mg) and excess potassium metal (0.680 mmol, 26.6 mg). The pressure tube was subjected to 110° C. for 24 h. After confirming the formation of product by ¹H and ¹¹B NMR spectroscopy, the mixture was brought to room temperature before bringing into the glove box. The solution was filtered through a celite pad, and the solvent was evaporated under reduced pressure that gives a yellow residue. The yellow residue was further washed with n-pentane (3×1 mL) and dried again under high vacuum which yielded a yellow crystalline product. The final product was KB^{Me}oCb₂ with isolated yields of 59%.

Single crystals for X-ray diffraction studies were grown from a 1:1 dichloromethane solution of KB^{Me}oCb₂ by vapor diffusion into toluene at 23° C.

Yield: 59.1%, 67.7 mg; mp: >yy ° C.; ¹H NMR (400 MHZ, C₆D₆): δ=3.46-1.46 (m, 26H) ppm; ¹³C{¹H} NMR (101 MHZ, C₆D₆): δ=67.9, 25.7 ppm; ¹¹B{¹H} NMR (128 MHZ, C₆D₆): δ=−1.4 (s), −3.0 (s), −5.5 (s), −6.3 (s), −6.7 to −13.5 (m), −15.4 (s) ppm; ¹¹B NMR: δ=−1.4 (d, J=165.1 Hz), −6.4 (d, J=170.2 Hz), −8.3 to −13.7 (m), −15.4 (m) ppm.

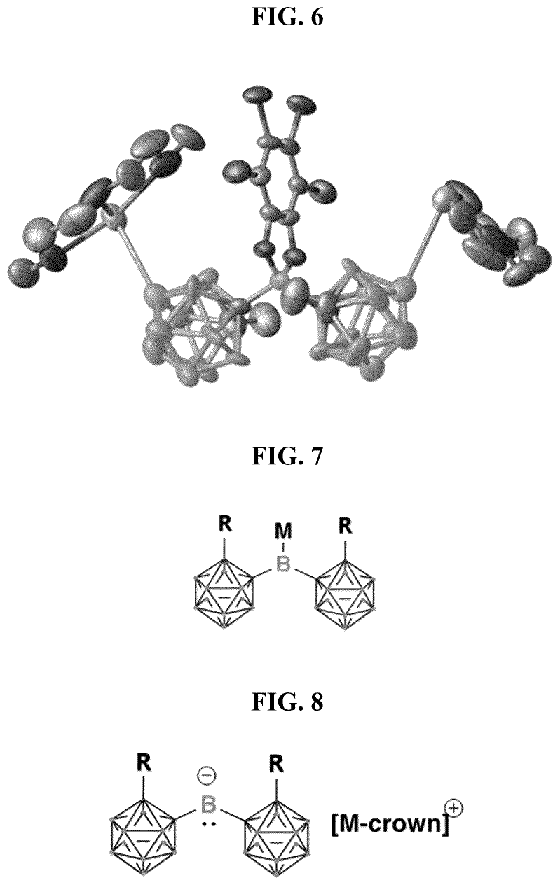

Characterization of [B^{Me}oCb₂][Na-18-crown-6]: ¹H NMR (400 MHZ, tol-d8): δ=3.68-1.70 (m, 50H) ppm; ¹³C{¹H} NMR (101 MHZ, tol-d8): δ=68.9, 67.1, 25.4 ppm; ¹¹B{¹H} NMR (128 MHz, tol-d8): δ=−0.8 (s), −5.9 (s), −5.5, −6.8 to −13.7 (m) ppm; ¹¹B NMR: δ=−0.7 (d, J=120.3 Hz), −3.0 to −13.7 (m), −14.1 (m) ppm.

[K-18-crown-6][TCQB^{Me}oCb₂] and [PPh₃CuB^{Me}oCb₂] were synthesized as described below. FIG. 5 shows a crystal structure of [K-18-crown-6][TCQB^{Me}oCb₂]. FIG. 6 shows a crystal structure of [PPh₃CuB^{Me}oCb₂].

[K-18-crown-6][TCQB^{Me}oCb₂]: To a solution of KB^{Me}oCb₂ (41 mg, 0.11 mmol) in 3 mL toluene, 18-crown-6 (29.8 mg, 0.11 mmol) and tetrachloro-quinone (27.7 mg, 0.11 mmol) were added in a pressure tube. The contents of mixture were heated to 150° C. for 4 h. The reaction was passed through a pad of celite and the volatiles removed under vacuum. The residue was washed with pentane (2×1 mL) to afford the product. Single crystals for X-ray diffraction studies were grown by vapor diffusion of concentrated ether solution of [K-18-crown-6][TCQB^{Me}oCb₂] into hexane at room temperature. ¹H NMR (600 MHZ, CDC₁₃): δ=3.63 (s, 48H), 2.72-1.57 (m, 26H) ppm; ¹³C{¹H} NMR (151 MHz, CDCl₃): δ=148.0, 120.8, 112.3, 70.5, 61.7, 26.1, 1.2 ppm; ¹¹B{¹H} NMR (193 MHZ, CDC₁₃): δ=14.4 (s), −1.7 (s), −6.7 (s), −8.0 to −13.3 (m) ppm; ¹¹B NMR (193 MHZ, CDC₁₃): δ=14.4 (s), −1.7 (d, J=100 Hz), −6.7 (d, J=93 Hz), −8.1 to −13.1 (m) ppm. HRMS (+ESI): calculated for [C₁₂H₂₄O₆K]⁺[M]⁺303.1202; found 303.1174; (−ESI): calculated for [C₁₂B₂₁H₂₆O₂Cl₄]⁻[M]⁻ 571.2751; found 571.2762.

[PPh₃CuB^{Me}oCb₂]: A solution of Ph₃PCuCl (0.0536 mmol, 19.4 mg) (3 mL) in toluene was added to a solution of KB^{Me}oCb₂ (0.0559 mmol, 20.4 mg) in 5 mL of toluene. The reaction was stirred for 45 min at 23° C. after volatiles were removed in vacuo. The off-white solid was washed with cold n-pentane (3×5 mL). Single crystals for X-ray diffraction studies were grown from a concentrated mixture of toluene/pentane at −35° C. .1H NMR (400 MHz, C6D6): δ=7.22 (m, 5H), 6.95-6.99 (m, 10H), 3.26-2.26 (m, 20H), 1.82 (s, 6H) ppm; ³¹P{¹H} NMR (162 MHz, C₆D₆): δ=−4.15 (br, s) ppm; 11B{¹H} NMR (128 MHz, C₆D₆): δ=23.5 (br, s), −2.9 (s), −5.3 (s), −8.8 (s), −15.4 (s) ppm; 13C{¹H} NMR (101 MHz, C₆D₆): δ=133.8, 131.3, 129.5, 70.4, 67.5, 23.0 ppm.

What is claimed is:

1. A bis(ortho-carboranyl)boryl compound having a structure of: 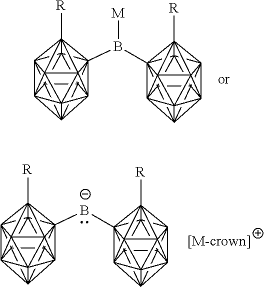
wherein each icosohedron structure is an ortho-carborane unit, wherein M is a Group I metal, wherein M-crown is a crown ether, a chelating ether, or an amine complexed with a Group I metal, and wherein R is an organic substituent.

2. The bis(ortho-carboranyl)boryl compound of claim 1 wherein M is Li, Na, or K, and wherein M-crown is a crown ether, a chelating ether, or an amine complexed with Li, Na or K.

3. The bis(ortho-carboranyl)boryl compound of claim 1 wherein R is methyl.

4. A method for synthesizing a bis(ortho-carboranyl)boryl compound, comprising:
reacting XB^{R}oCb₂ with 2.5 equivalents of a Group I metal in toluene, wherein X is a halogen, and where R is an organic substituent.

5. The method of claim 4, wherein the Group I metal is Li, Na, or K, and wherein X is Cl, Br, or I.

6. The method of claim 4, wherein R is methyl.

7. A method for preparing metal complexes, comprising:
reacting a bis(ortho-carboranyl)boryl compound with a metal reagent to form the intermediate compound, wherein the bis(ortho-carboranyl)boryl compound has a structure of MB^{R}oCb₂, where M is a cation of a Group 1 atom or M is a crown ether complexed with the cation of a Group I atom, and R is an organic substituent.

8. The method of claim 7, wherein the Group I atom is Li, Na, or K.

9. The method of claim 7, wherein R is methyl.
